(19) United States
(12) Patent Application Publication
(10) Pub. No.: US 2010/0027806 A1
(43) Pub. Date: Feb. 4, 2010

(54) DISTRIBUTED EMITTER VOICE LIFT SYSTEM

(75) Inventors: John C. Heine, Weston, MA (US); Thomas R. Horrall, Harvard, MA (US); Jonathan D. Kemp, Jamaica Plain, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: CAMBRIDGE SOUND MANAGEMENT, LLC, Cambridge, MA (US)

(21) Appl. No.: 12/518,460

(22) PCT Filed: Dec. 14, 2007
(86) PCT No.: PCT/US2007/025562

§ 371 Date: Jun. 10, 2009

Related U.S. Application Data
(60) Provisional application No. 60/874,818, filed on Dec. 14, 2006.

(51) Int. Cl. H04R 27/00; G10L 15/20; H04L 12/66

(52) U.S. Cl. 381/73.1; 381/82; 370/352

(57) ABSTRACT

A system and method of providing sound reinforcement in a classroom, an office, a conference room, an auditorium, or any other suitable venue. The system includes at least one microphone, a receiver, a sound masking signal generator, a system controller, and a plurality of spatially distributed loudspeakers. The microphone detects the speech of a talker, generates at least one voice signal corresponding to the detected speech, and provides the generated voice signal to the receiver. The sound masking signal generator generates at least one sound masking signal having a specified sound masking spectrum. The system controller receives the voice signal and the sound masking signal from the receiver and the sound masking signal generator, respectively, and provides the voice and sound masking signals to the loudspeakers over respective channels. The loudspeakers emit acoustic voice and sound masking signals simultaneously and directly into the venue to obtain a more uniform sound field coverage for the acoustic voice signals and more uniform levels of the acoustic sound masking signals throughout the venue.

### CROSS REFERENCE TO RELATED APPLICATIONS

This application claims benefit of U.S. Provisional Patent Application No. 60/874,818 filed Dec. 14, 2006 entitled DISTRIBUTED EMITTER VOICE LIFT SYSTEM WITH OPTIONAL SOUND MASKING.

### STATEMENT REGARDING FEDERALLY SPONSORED RESEARCH OR DEVELOPMENT

Not applicable

### BACKGROUND OF THE INVENTION

Voice reinforcement systems (also called “voice lift” systems) are known that may be employed to improve communication by increasing the intelligibility of human speech. Such voice lift systems may be deployed in classrooms, offices, conference rooms, auditoriums, or any other suitable venue for small or large gatherings to assure that listeners can both hear the voice and understand the speech of a talker at all listener locations within the venue. For example, a simple voice lift system for use in an office or conference room may include at least one microphone, a mixer/amplifier sub-system, and at least one loudspeaker. In one exemplary application, the office or conference room in which the voice lift system is deployed may be partitioned into a plurality of zones, and at least one microphone and at least one loudspeaker may be disposed in each one of the zones. Further, to assure that listeners located within each of the zones can hear and understand a talker situated within any one of the zones, the mixer/amplifier sub-system may selectively direct voice signals generated by the microphone disposed within the talker's zone to the loudspeakers associated with one or more of the other zones, while at least partially limiting the voice signals provided to the loudspeakers within the talker's zone. In this way, the simple voice lift system can enhance the ability of listeners to comprehend the talker's speech at the various zone locations within the office or conference room.

The simple voice lift system described above has drawbacks, however, especially when it is deployed in an open-plan classroom or office environment. For example, in a large, open-plan classroom, the talker may be an instructor such as a teacher or a professor, and the listeners may be students listening to the instructor's lecture. Although the above-described voice lift system may be deployed in such a classroom environment to improve the intelligibility of the instructor's speech, unwanted sound resulting from student activity inside or outside of the classroom and/or other background or ambient noise may be generated at levels high enough to distract the student listeners from the instructor's lecture.

It would therefore be desirable to have an improved system and method of providing sound reinforcement for use in a classroom, an office, a conference room, an auditorium, or any other suitable venue that allows listeners to hear and understand the voice of at least one talker with increased clarity and intelligibility at all listener locations. Such a system and method would allow a talker's voice to sound equally natural and equally intelligible at all of the listener locations. It would also be desirable to have a sound reinforcement system that provides the capability of reducing or eliminating unwanted sound including background or other ambient noise emanating from inside or outside of the venue in which the system is deployed, thereby allowing listeners at all of the listener locations to hear and understand the voice of a talker with less distraction.

### BRIEF SUMMARY OF THE INVENTION

In accordance with the present invention, an improved system and method is disclosed for providing sound reinforcement in a classroom, an office, a conference room, an auditorium, or any other suitable venue. The presently disclosed system and method can be configured to provide a voice reinforcement (“voice lift”) function via a plurality of spatially distributed emitters (“loudspeakers”), thereby providing a more uniform sound field coverage and allowing a talker's voice to sound equally natural and equally intelligible at all listener locations within the venue of interest. The disclosed system and method can also be configured to provide a sound masking function, preferably via the same plurality of spatially distributed loudspeakers used for the voice lift function. In this way, more uniform levels of acoustic sound masking signals can be generated throughout the venue in which the system is deployed.

In one embodiment, the presently disclosed sound reinforcement system includes a plurality of microphones, a receiver, a sound masking signal generator, a system controller, and a plurality of spatially distributed emitters (“loudspeakers”). Each of the microphones is operative to detect the speech of a talker, and to generate at least one voice signal corresponding to the detected speech. The voice signal generated by each microphone may be a wireless (e.g., infrared (IR) or radio frequency (RF)) voice signal, and the receiver may be a wireless (e.g., IR or RF) receiver operative to receive the wireless voice signals from the microphones. For example, when the disclosed sound reinforcement system is deployed in a classroom environment, one of the microphones may be worn by an instructor either on a lanyard, clipped as a lavaliere, or as a headset, while one or more of the other microphones may be of a hand-held type suitable for being passed from one student to another during periods of student participation. Further, the wireless receiver may be configured to be mountable to the ceiling to assure that the IR or RF signals generated by the microphones worn by the instructor and held by the students are received with minimal obstruction and/or interference. The sound masking signal generator is configured to store at least one set of information specifying at least one sound masking spectrum, and to generate at least one electrical sound masking signal having the sound masking spectrum specified by the stored set of information. The system controller is operative to receive the voice signals and the sound masking signal from the microphones and the sound masking signal generator, respectively, to provide the voice signals on at least one first channel, and to provide the sound masking signal on at least one second channel. Like the wireless receiver, the plurality of spatially distributed loudspeakers is configured to be mountable at the ceiling level. Each of the loudspeakers has a low directivity index, and is arranged to face downwardly from the ceiling. In addition, each of the loudspeakers can be configured to receive both the voice signals and the sound masking signal provided on the first channel and the second channel, respectively, and to emit acoustic voice and sound masking signals corresponding to the received voice and sound masking signals, respectively, simultaneously and directly into the venue in which the system is deployed. As a result, a more uniform sound field coverage for the acoustic voice signals, and more uniform levels of the acoustic sound masking signals, can be obtained throughout the venue of interest.

In one embodiment, the system controller is operative both to adjust an output level of the sound masking to reduce the level of distraction from noise either inside or outside of the venue, and to adjust the acoustic voice signal based at least in part upon sound masking spectra of two or more mutually incoherent electrical sound masking signals to obtain at least one specified performance characteristic, e.g., a specified signal-to-noise ratio (SNR).

The presently disclosed sound reinforcement system provides features that address the communication needs of individuals who gather to meet in small or large venues such as classrooms, offices, conference rooms, auditoriums, etc. For example, the plurality of spatially distributed loudspeakers has low voltage and power requirements and can be easily installed at the ceiling of the venue to provide distributed audio delivery and a more uniform sound field coverage, thereby allowing a reduced overall sound level for a given Articulation Index. Further, to mitigate delay-related phenomena caused by the Haas effect (also called the “precedence effect”) when the system is deployed in larger venues, the receiver can be configured to perform microphone localization processing, including calculating time delays to be applied to the voice signals generated by the talker's microphone based upon the relative distances between the microphone and the spatially distributed loudspeakers. As a result, the talker's voice can be made to have a more natural sound at all listener locations in the venue no matter where the talker is currently located.

Moreover, when the disclosed sound reinforcement system is deployed in a classroom environment, the system can employ the sound masking function to reduce the actual or perceived level of student activity noise and/or background or ambient noise emanating from inside and/or outside of the classroom, thereby allowing the students concentrate on the teacher, to study, to take tests, and to perform group work with significantly less distraction. In addition, the receiver can be configured to receive voice input signals from the instructor and one or more of the students simultaneously, and the system controller can be configured to provide the voice signals of the instructor and students on respective channels for subsequent transmission as acoustic signals via the spatially distributed loudspeakers. The receiver can also be configured to incorporate one or more internal antennas, and/or to interface with one or more external antennas, to obtain spatial diversity or any other desired RF diversity reception for reducing the occurrence of drop-outs as the instructor speaks into the microphone while moving about the classroom. Rechargeable battery packs and/or docking stations may also be provided for the instructor and student microphones.

Still further, the system controller can be configured to receive audio input signals from one or more local and/or external audio sources such as a compact disk (CD) player, a digital video disk (DVD) player, or a personal computer (PC), and/or one or more local and/or external paging sources. In the event it is desired to receive an audio input signal from an audio source external to the venue in which the system is deployed, the system controller can be provided with an analog or digital connection to any suitable local or wide area network or the Internet, and the desired audio input can be received over the network connection. For example, if the network connection is operative to connect the system controller to the Internet, then any suitable voice over Internet protocol (VoIP) may be employed to receive the desired audio input. The network connection may also be employed to connect the system controller to an external receiver over the VoIP network to provide near-instantaneous notification of an emergency or other event occurring within the venue. To that end, one or more of the microphones, such as the instructor's microphone in a classroom environment, may be provided with a pushbutton for remotely signaling the receiver of an actual or perceived emergency, and, in response to the signaling from the microphone, the receiver may provide an emergency signal to the system controller, causing a network connection between the controller and the external receiver to be automatically established over the VoIP network. In addition, the system controller can be configured to receive VoIP-based paging, alone or in combination with VoIP-based voice transmission, to enable emergency-mode VoIP telephony. For example, the system controller may employ VoIP paging to provide point-to-server communication of emergency or other information for subsequent re-distribution. The system controller may also employ VoIP voice transmission to provide point-to-point communication of emergency or other information between multiple venues in which like systems are deployed.

Other features, functions, and aspects of the invention will be evident from the Detailed Description of the Invention that follows.

### BRIEF DESCRIPTION OF THE SEVERAL VIEWS OF THE DRAWINGS

The invention will be more fully understood with reference to the following Detailed Description of the Invention in conjunction with the drawings of which:

FIG. 1 is a block diagram of a sound reinforcement system according to the present invention;

FIG. 2 is a block diagram illustrating a representative layout of spatially distributed loudspeakers included in the system of FIG. 1, for use in describing a microphone localization processing application;

FIG. 3 is a block diagram of a VoIP emergency or other event notification system incorporating the system of FIG. 1;

FIG. 4 is a block diagram of a VoIP point-to-point communication system incorporating the system of FIG. 1;

FIG. 5 is a block diagram illustrating the system of FIG. 1 employed in a VoIP pod-casting application; and

FIG. 6 is a block diagram illustrating the system of FIG. 1 employed in a VoIP paging application.

### DETAILED DESCRIPTION OF THE INVENTION

The entire disclosure of U.S. Provisional Patent Application No. 60/874,818 filed Dec. 14, 2006, entitled DISTRIBUTED EMITTER VOICE LIFT SYSTEM WITH OPTIONAL SOUND MASKING, is incorporated herein by reference.

An improved system and method is disclosed for providing sound reinforcement in a classroom, an office, a conference room, an auditorium, or any other suitable venue. The presently disclosed system and method can provide voice reinforcement (“voice lift”) functionality via a plurality of spatially distributed emitters (“loudspeakers”), providing a more uniform sound field coverage and allowing a talker's voice to sound equally natural and equally intelligible at all listener locations. The disclosed system and method can also provide sound masking functionality via the same plurality of spatially distributed loudspeakers used for the voice lift function, generating more uniform levels of acoustic sound masking signals throughout the venue in which the system is deployed.

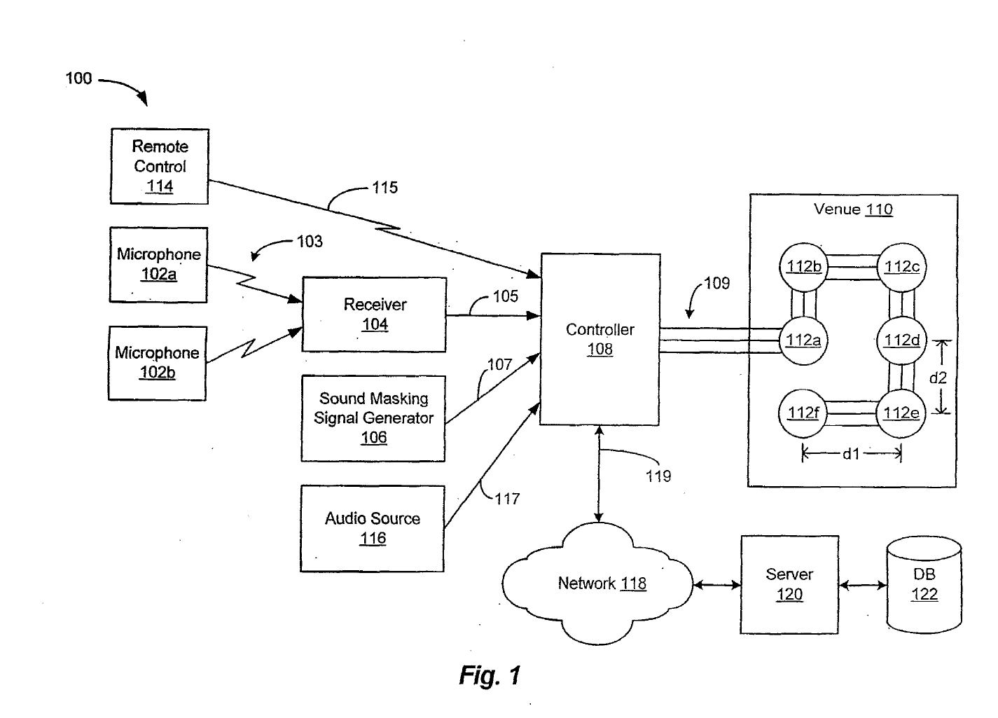

FIG. 1 depicts an illustrative embodiment of a sound reinforcement system 100, in accordance with the present invention. In the illustrated embodiment, the sound reinforcement system 100 includes a plurality of microphones 102a, 102b, at least one receiver 104, at least one sound masking signal generator 106, at least one system controller 108, and a plurality of emitters (“loudspeakers”) 112a, 112b, 112c, 112d, 112e, 112f spatially distributed within a venue 110. Each of the microphones 102a, 102b is operative to detect the speech of a human operator (the “talker”), to generate at least one voice signal corresponding to the detected speech, and to provide the voice signals to the receiver 104. As shown in FIG. 1, the voice signals generated by the microphones 102a, 102b correspond to wireless (e.g., infrared (IR) or radio frequency (RF)) voice signals 103, and therefore the receiver 104 is configured as a wireless (e.g., IR or RF) receiver. It should be appreciated, however, that the voice signals generated by the microphones 102a, 102b may alternatively be provided to the receiver 104 via wired connections. For example, the voice signals 103 may be provided to the receiver 104 using Institute of Electrical and Electronics Engineers (IEEE) 802.11, Bluetooth, or any other suitable wireless or wired communications protocol. In one embodiment, the receiver 104 is configured to be ceiling mountable to assure that the IR or RF signals 103 generated by the microphones 102a, 102b are received with minimal obstruction and/or interference. The receiver 104 provides electrical voice signals 105 corresponding to the wireless voice signals 103 generated by the microphones 102a, 102b to the system controller 108.

As shown in FIG. 1, the sound masking signal generator 106 is configured to generate at least one electrical sound masking signal 107 having a specified sound masking spectrum, and to provide the sound masking signal 107 to the system controller 108, which receives the voice signals 105 and the sound masking signal 107 from the receiver 104 and the sound masking signal generator 106, respectively. In one embodiment, the system controller 108 provides the voice signals 105 and the sound masking signal 107 to the six spatially distributed loudspeakers 112a-112f over multiple channels 109. For example, the system controller 108 may provide the voice signals on at least one first channel and the sound masking signal on at least one second channel, and then provide the voice and sound masking signals to the loudspeakers 112a-112f over the respective channels 109. Like the receiver 104, each of the spatially distributed loudspeakers 112a-112f is configured to be ceiling mountable. In one embodiment, each of the loudspeakers 112a-112f has a low directivity index, and is arranged to face downwardly from the ceiling, thereby allowing the respective loudspeaker to emit acoustic voice and sound masking signals simultaneously in one or more direct paths to the ears of individuals (the “listeners”) located in the venue 110 in which the system 100 is deployed. As a result, a more uniform sound field coverage for the acoustic voice signals, and more uniform levels of the acoustic sound masking signals, can be obtained throughout the venue 110. In an alternative embodiment, the plurality of loudspeakers can include two or more sets of loudspeakers, in which at least one set of loudspeakers is used to emit the acoustic voice signals and at least one other set of loudspeakers is used to emit the acoustic sound masking signals.

In one embodiment, the sound masking signal generator 106 is configured to store at least one set of information specifying at least one sound masking spectrum, and to generate at least one electrical sound masking signal having the sound masking spectrum specified by the stored set of information. The sound masking signal generator 106 is therefore like the sound masking signal generator described in U.S. Pat. No. 7,194,094 (the '094 patent) issued Mar. 20, 2007 entitled SOUND MASKING SYSTEM and assigned to the same assignee of the present invention, the entire disclosure of which is incorporated herein by reference. Specifically, the sound masking signal generator 106 operates to provide two or more channels of mutually incoherent electrical sound masking signals having temporally random signals with frequency characteristics within the specified sound masking spectrum. In one embodiment, the predetermined sound masking spectrum is designed with less “roll off” in sound intensity in high frequency components, e.g., frequency components above approximately 1250 Hz, to provide superior sound masking in an open plan venue such as an open plan classroom or office.

As described above, each of the spatially distributed loudspeakers 112a-112f is configured to be ceiling mountable, to have a low directivity index, and to be arranged to face downwardly from the ceiling to allow the respective loudspeaker to emit the acoustic voice and sound masking signals simultaneously in one or more direct paths to the ears of the listeners located in the venue 110. In the illustrated embodiment, each of the loudspeakers 112a-112f is like the loudspeaker assembly described in the above-referenced '094 patent, having the low directivity index and being disposable within an aperture in the ceiling. As shown in FIG. 1, the six loudspeakers 112a-112f are disposed in a 3-by-2 arrangement spaced apart from one another by distances d1, d2 to provide sufficient overlap in the acoustic voice and sound masking signals emitted by adjacent loudspeakers, thereby producing a uniform sound field coverage and uniform levels of acoustic sound masking signals throughout the venue 110. It should be appreciated, however, that any other suitable number of loudspeakers in any other suitable arrangement may alternatively be employed. For example, the loudspeakers 112a-112f can be wired directly to the system controller 108, or daisy chained from one loudspeaker to the next via wired connections.

As shown in FIG. 1, the sound reinforcement system 100 further includes a remote control unit 114, an external audio source 116, a network 118, a server 120, and a database 122. In the illustrated embodiment, the remote control unit 114 is configured to use IR, RF, or any other suitable wireless signals 115 to transmit data and/or commands to the system controller 108 for controlling the levels of one or both of the acoustic voice signals and the acoustic sound masking signals emitted by the loudspeakers 112a-112f in the venue 110. The external audio source 116 is configured to provide additional audio input signals 117 to the system controller 108 for subsequent transmission in the venue 110 by the loudspeakers 112a-112f. For example, the external audio source 116 may be a compact disk (CD) player, a digital video disk (DVD) player, a personal computer (PC), a source of paging signals, or any other suitable audio source. The system controller 108 is configured to be communicably connectable to the network 118 via a network connection 119. For example, the network 118 may include one or more of a local area network (LAN), a wide area network (WAN), the Internet, or any other suitable network. The system controller 108 is operative to communicate over the network 118 with the server 120, which can include or be externally connectable to the database 122. In one embodiment, the server 120 operates in conjunction with the database 122 as a database server to provide a structured collection of data files in the MP3 format or any other suitable file format for storing digital audio data.

In an illustrative mode of operation, the sound reinforcement system 100 is configured to provide a voice reinforcement (“voice lift”) function in a classroom environment. To that end, one of the microphones 102a, 102b may be designed to be worn by a classroom instructor either on a lanyard, clipped as a lavaliere, or as a headset, and another one of the microphones 102a, 102b may be designed as a hand-held type suitable for being passed from one student to another during periods of student participation. The system controller 108 receives the voice signals 105 corresponding to the speech detected by the respective instructor and student microphones, and optionally any additional audio input signals 117 that the instructor may provide via a CD player, a DVD player, a PC, etc. In one embodiment, the voice signals 105 and the additional audio input signals 117 are provided to the system controller 108 simultaneously. The system controller 108 amplifies and processes the voice and other audio input signals 105, 117, as appropriate, for subsequent distribution in the venue 110, i.e., the classroom, via the loudspeakers 112a-112f.

The sound reinforcement system 100 provides features that address the communication needs of individuals who gather to meet in small or large venues such as instructors and students in a classroom environment. According to one such feature, the system controller 108 provides microphone localization processing to locate the microphone of the instructor, and to apply suitable delays to the voice and other audio signals provided to the spatially distributed loudspeakers 112a-112f based on the location of the instructor's microphone. As a result, the instructor's voice can be made to have a more natural sound at all student locations no matter where the instructor is currently located in the classroom. Such microphone localization processing is particularly useful in a large, open plan classroom environment.

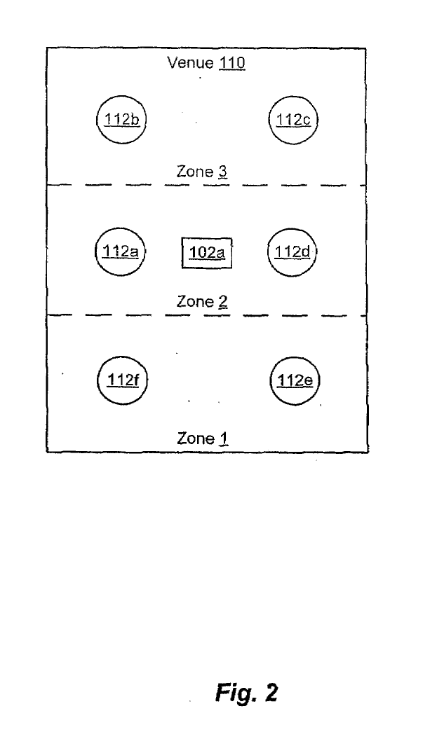

FIG. 2 depicts a representative layout of the spatially distributed loudspeakers 112a-112f for use in describing the microphone localization processing of the system controller 108 (see FIG. 1). As shown in FIG. 2, the representative layout of the loudspeakers 112a-112f is like that depicted in FIG. 1, i.e., the six loudspeakers 112a-112f are disposed in a 3-by-2 arrangement spaced apart from one another by distances sufficient to provide a degree of overlap in the acoustic signals emitted by adjacent loudspeakers. The microphone localization processing can be employed to mitigate delay-related phenomena caused by the Haas effect (also called the “precedence effect”) when the system is deployed in a large venue such as a large, open plan classroom.

Specifically, the system controller 108 performs microphone localization processing by calculating time delays to be applied to voice signals generated by the talker's microphone based upon the relative distances between the microphone and the respective loudspeakers spatially distributed throughout the venue. The system controller 108 typically calculates and applies such time delays when the venue is large enough to have listener locations where the observed difference between the arrival time of speech via the amplified signal path through the loudspeakers, and the arrival time of the same speech via the direct propagation signal path from the talker, exceeds approximately 20 msec. By tracking the talker's microphone location and applying the calculated time delays to the amplified signals, the speech emanating from the loudspeakers can be made to sound more natural at all listener locations. Applying the calculated time delays to the amplified signals also allows the listeners to locate the talker more easily. For example, in a classroom environment, students located at the rear of the classroom will be able to locate an instructor lecturing at the front of the classroom more easily because the sound of the instructor's voice emanating from the loudspeakers will be delayed, thereby causing the amplified sound from the loudspeakers to reach the students at substantially the same time as the sound of the instructor's unamplified voice.

To calculate the appropriate amount of time delay to be applied to the amplified signals, the location of the talker's microphone, e.g., the instructor's microphone 102a, is estimated relative to the locations of the loudspeakers 112a-112f spatially distributed in the venue 110, e.g., the classroom. As shown in FIG. 2, the exemplary venue 110 is partitioned into a plurality of zones 1, 2, 3 such that the loudspeakers 112e-112f are disposed in zone 1, the loudspeakers 112a, 112d are disposed in zone 2, and the loudspeakers 112b-112c are disposed in zone 3. Further, in this example, the instructor's microphone 102a is approximately centrally located in the classroom within zone 2. Next, the time delays to be applied to the amplified sound emanating from the loudspeakers 112a-112f are calculated based on the time required for sound to travel from the location of the instructor's microphone 102a to the locations of the loudspeakers 112a-112f in the respective zones 1, 2, 3. In one embodiment, the system controller 108 can apply the calculated time delays to the amplified signals by digitizing the voice signals 105 provided by the receiver 104, buffering the digitized voice signals, and sampling the buffered signals at the calculated time delays. For example, a first time delay may be applied to the sound emanating from the loudspeakers 112e-112f in zone 1 and a second time delay may be applied to the sound emanating from the loudspeakers 112b-112c in zone 3, while no time delay is applied to the sound emanating from the loudspeakers 112a, 112d in zone 2 where the instructor's microphone 102a is located.

In one embodiment, the location of the instructor's microphone 102a in the venue 110, e.g., the classroom, is estimated by using a wavefront curvature technique. To employ the wavefront curvature technique, both the microphone 102a and the receiver 104 may be implemented as IR devices. For example, the IR receiver 104 may be configured as a two dimensional array of IR point sensors. By measuring the time delay of the IR signals generated by the microphone 102a between the IR point sensors of the two dimensional array, such as by cross-correlation of the IR sensor outputs, the curvature of the arriving IR wavefront, the direction of the microphone 102a relative to the receiver 104, and the distance between the microphone 102a and the receiver 104 can be estimated. Using the estimated direction and distance of the microphone 102a relative to the receiver 104 and the known locations of the loudspeakers 112a-112f in the venue 110, the distances between the microphone 102a and the respective loudspeakers 112a-112f can be determined. The appropriate time delays to be applied to the sound emanating from the loudspeakers 112a-112f can then be calculated based on the distances between the microphone 102a and the respective loudspeakers 112a-112f.

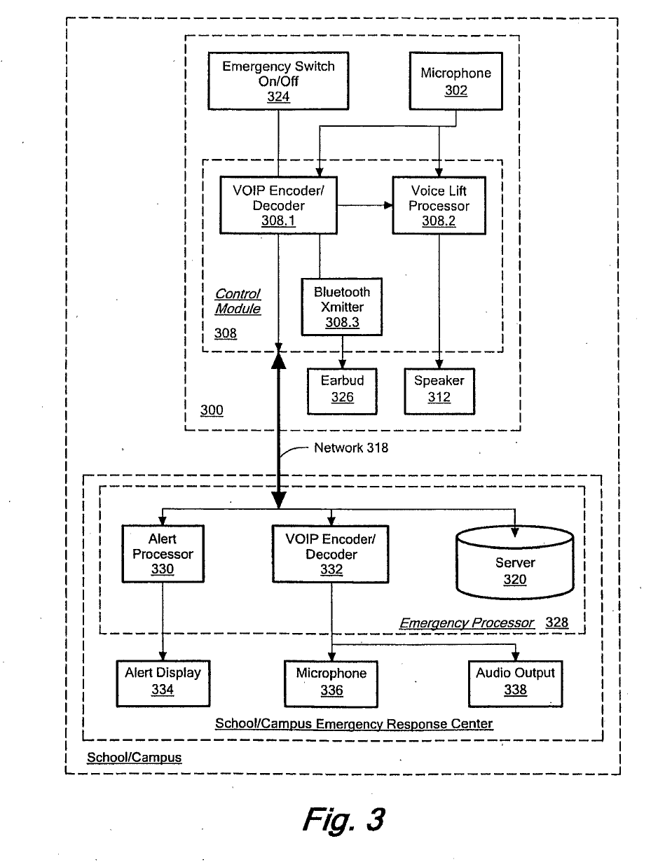

According to another feature, the sound reinforcement system 100 of FIG. 1 can be incorporated for use in a VoIP emergency or other event notification system, as illustrated in FIG. 3. As shown in FIG. 3, a sound reinforcement system 300 deployed in a classroom environment can be communicably connected to a school or campus emergency response center via a network 318. The sound reinforcement system 300 includes at least one microphone 302, a system controller 308, at least one loudspeaker 312, at least one optional ear-bud device 326, and an emergency on/off switch 324 for enabling the emergency or other event notification functionality. The microphone 302 is communicably connected to a VoIP encoder/decoder 308.1 and a voice lift processor 308.2 contained in the system controller 308. The emergency on/off switch 324 is also communicably connected to the VoIP encoder/decoder 308.1, which in turn is communicably connectable to the ear-bud device 326 via a Bluetooth transmitter 308.3 contained in the system controller 308. As further shown in FIG. 3, the school or campus emergency response center includes an emergency processor 328 containing an alert processor 330, a VoIP encoder/decoder 332, and a server 320, an alert display 334, at least one microphone 336, and at least one audio output 338. The system controller 308 within the sound reinforcement system 300 can communicate with the emergency processor 328 over the network 318. In addition, the alert processor 330 can provide alert outputs for display on the alert display 334, and the VoIP encoder/decoder 332 can receive input signals and provide output signals from/to the microphone 336 and the audio output 338, respectively.

Accordingly, if an emergency occurs in the classroom, then the network 318 connecting the sound reinforcement system 300 to the school/campus emergency response center can be used as a communications path to inform school officials and/or emergency responders of both the occurrence and the characteristics of the emergency. In one embodiment, the network 318 corresponds to a school/campus data network generally accessible from every classroom in the school or on the campus. The two-way VoIP capability provided over the network 318 allows both emergency signaling and voice communications between the sound reinforcement system 300 and the school/campus emergency response center.

In one embodiment, such emergency communication is implemented at the classroom in three steps, specifically, (1) notifying the school/campus emergency response center of the emergency, (2) describing the emergency in detail to the emergency response center, and (3) responding to instructions from the emergency response center for mitigation of the emergency. For example, such emergency notification may be accomplished by activating a pushbutton or a series of pushbuttons on the emergency on/off switch 324, which may be located on the lavaliere microphone, on one of the hand-held microphones, or on the voice lift unit itself, or by providing speech recognition in the system controller 108. Upon activating the emergency notifying signal, the time and location of the emergency is determined and recorded at the server 320 and subsequently routed to the emergency responders. Subsequent speech further describing the nature of the emergency, provided via the microphone 302, can also be recorded at the server 320 and routed to the emergency responders. Upon receipt of the time, location, and description of the emergency, the emergency responders can, should the situation require it, provide information to an instructor alone through the ear-bud device 326. The emergency responders can also activate emergency paging in the classroom and/or on a wider basis (e.g., building-wide or campus-wide), and initiate a two-way dialog with the individuals in the classroom over the network 318 for implementing possible emergency mitigation scenarios.

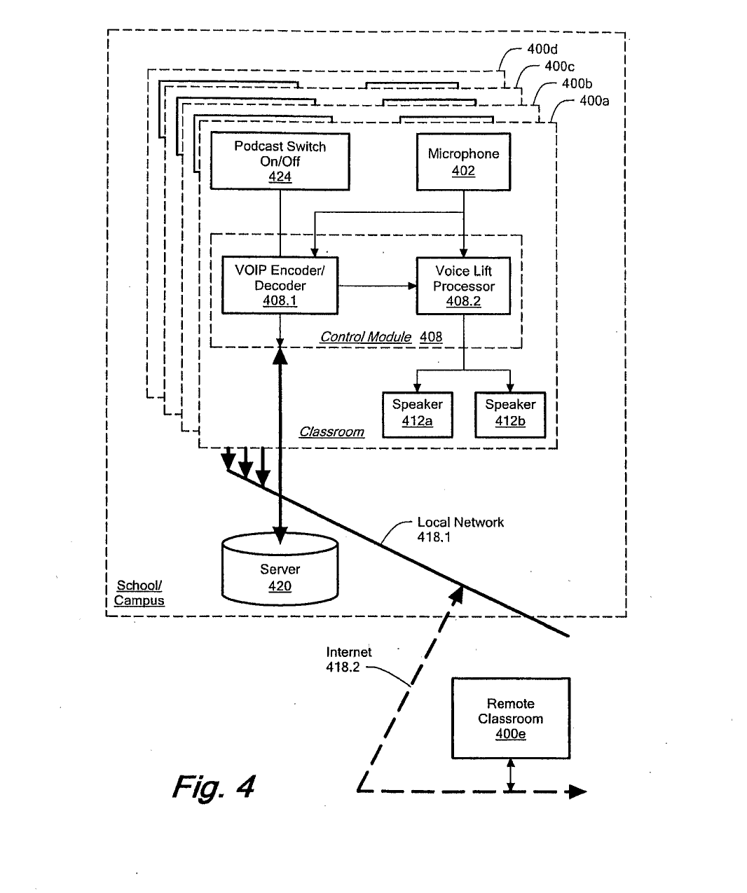

According to still another feature, the sound reinforcement system 100 of FIG. 1 can be incorporated for use in a VoIP point-to-point communication system, as illustrated in FIG. 4. As shown in FIG. 4, a plurality of sound reinforcement systems 400a, 400b, 400c, 400d can be deployed in multiple classrooms, respectively, either in a school or on a campus. Further, each of the sound reinforcement systems 400a-400d is communicably connected to a server 420 via a local network 418.1, which in turn is communicably connected to an external network 418.2 such as the Internet. Each of the systems 400a-400d includes at least one microphone 402, a system controller 408, a plurality of loudspeakers 412a, 412b, and a network connection on/off switch 324 for enabling the VoIP point-to-point communication functionality. The microphone 402 is communicably connected to a VoIP encoder/decoder 408.1 and a voice lift processor 408.2 contained in the system controller 408. The pod-cast on/off switch 424 is also communicably connected to the VoIP encoder/decoder 408.1. Moreover, the system controller 408 within each sound reinforcement system 400a-400d can communicate with the server 420 over the local network 418.1, and with a system 400e deployed in a remote classroom over the Internet 418.2. In the illustrated embodiment, the system 400e is like the sound reinforcement systems 400a-400d, and is deployed in the remote classroom for enabling VoIP point-to-point communication, e.g., for remote learning, with the systems 400a-400d over the networks 418.1-418.2.

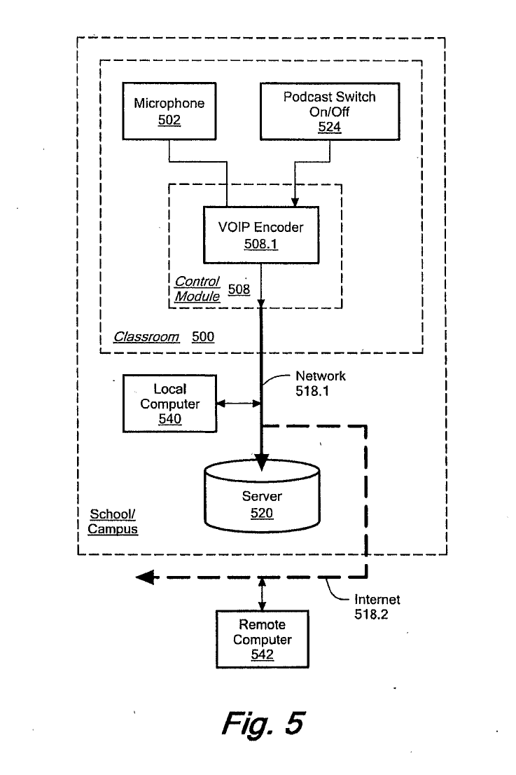

According to yet another feature, the sound reinforcement system 100 of FIG. 1 can be employed in a VoIP pod-casting application, as illustrated in FIG. 5. As shown in FIG. 5, a sound reinforcement system 500 deployed in a classroom environment can be communicably connected to a local computer 540 and a server 520 via a local network 518.1, and to a remote computer 542 via the local network 518.1 and an external network 518.2 such as the Internet. The sound reinforcement system 500 includes at least one microphone 502, a system controller 508, and an on/off switch 524 for enabling the VoIP pod-casting functionality. The microphone 502 is communicably connected to a VoIP encoder 508.1 contained in the system controller 508. The pod-cast on/off switch 524 is also communicably connected to the VoIP encoder 508.1, which in turn is connectable to the network 518.1. In the VoIP pod-casting application, the capability of the system 500 to convert sounds into data packets allows archiving, storing, recovering, and replaying of those sounds concurrently or at some later time. For example, a lecture presented by an instructor, inclusive or exclusive of commentary from the student audience, may be recorded and archived, allowing others who may have missed the lecture, or may wish to revisit the lecture in the course of studying, to download and replay (e.g., pod-cast) the lecture at anytime in the future. In one embodiment, the system 500 can record digital audio, convert it to any suitable audio format, e.g., compressed (MP3, MP4, etc.) or uncompressed (WAV, etc.), and allow the instructor or others to catalog the recording appropriately. Such recording capability allows instructors and their supervisors to listen to the instructors' lectures at some later time for the purpose of oversight and/or evaluation. In addition, the system 500 can be combined with a video recording/broadcasting system to create integrated audio/video broadcasts for use in remote learning.

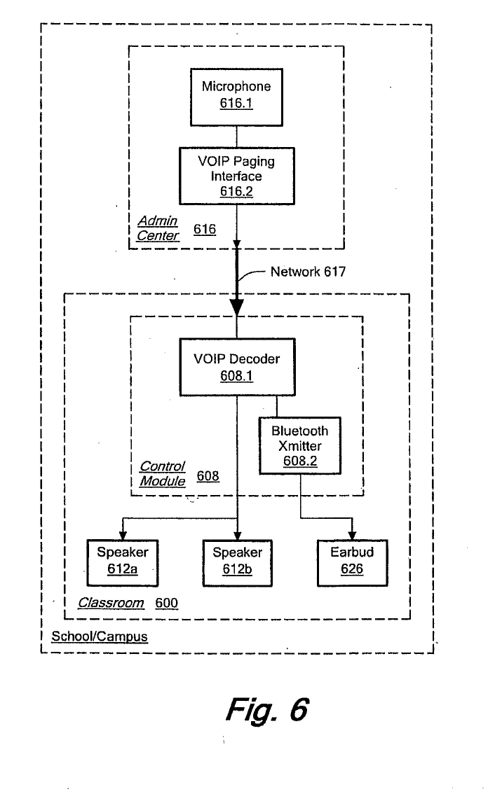

According to still yet another feature, the sound reinforcement system 100 of FIG. 1 can be employed in a VoIP paging application, as illustrated in FIG. 6. As shown in FIG. 6, a sound reinforcement system 600 deployed in a classroom environment can be communicably connected to an administration center 616 via a local network 617. The administration center 616 includes at least one microphone 616.1 and a VoIP paging interface 616.2. The sound reinforcement system 600 includes a system controller 608, a plurality of loudspeakers 612a, 612b, and an optional ear-bud device 626. The system controller 608 includes a VoIP decoder 608.1, which is connected to the loudspeakers 612a, 612b. In this example, the VoIP decoder 608.1 is also communicably connectable to the optional ear-bud device 626 via, e.g., a Bluetooth transmitter 608.2 contained in the system controller 608. In the VoIP paging application, the system controller 608 converts voice signals generated by the microphone 616.1 into data packets, which may be received by any compatible VoIP device (e.g., a telephone, a PC, etc.) or by another installation of the sound reinforcement system (not shown). The sound corresponding to the data packets may subsequently be played through the spatially distributed loudspeakers 612a, 612b disposed in one or more of the respective systems.

Having described the above illustrative embodiments, other alternative embodiments or variations may be made. For example, the sound reinforcement system may be configured to distribute a voice lift function and a sound masking function via separate loudspeaker assembly systems; e.g., the sound masking signal may be distributed via upwardly facing loudspeakers in the ceiling plenum. The sound reinforcement system may be configured to include one or more personal receiver/amplifier/loudspeaker units for use by audibly challenged individuals in the venue in which the system is deployed. In addition, the sound reinforcement system may be configured to provide for the distribution of two or more channels of sound generated by one or more music sources. For example, the system can be configured to associate adjacent loudspeakers with different channels for appropriately distributing, e.g., the “right” and “left” channels of stereophonic sound. Because the subjective improvement of musical sound from stereophonic music sources is mostly due to the incoherence among the channels, the spatially distributed loudspeakers need not be arranged in the right-left configuration of traditional stereo sound systems. The system can also be provided with one or more “woofer” loudspeakers, cross-over filters, and/or power amplifiers to raise the output level and/or improve the quality of the musical sound.

In addition, it was described above that the system controller can receive voice signals and a sound masking signal, and provide the voice signals and the sound masking signal to a plurality of spatially distributed loudspeakers over multiple channels. In alternative embodiments, the system controller can be configured to incorporate any suitable digital signal processing capability to allow a user to select any desired functionality or any desired combination of functionalities, including but not limited to voice lift, sound masking, paging, pod-casting, emergency broadcasting, and/or remote learning.

It will be appreciated by those of ordinary skill in the art that modifications to and variations of the above-described distributed emitter voice lift system may be made without departing from the inventive concepts disclosed herein. Accordingly, the invention should not be viewed as limited except as by the scope and spirit of the appended claims.

What is claimed is:

1. A sound system having voice lift and sound masking capabilities for use in a predetermined area of a building, said system comprising:
at least one microphone operative to detect speech, and to provide at least one electrical voice signal corresponding to the detected speech;
at least one receiver operative to receive said at least one electrical voice signal from said at least one microphone;
at least one sound masking signal generator operative to generate at least one electrical sound masking signal;
at least one system controller operative to receive said at least one electrical voice signal from said at least one receiver, to receive said at least one electrical sound masking signal from said sound masking signal generator, to provide said at least one electrical voice signal on at least one first channel, and to provide said at least one electrical sound masking signal on at least one second channel; and
a plurality of loudspeaker assemblies, each of said plurality of loudspeaker assemblies including at least one first input operative to receive said at least one electrical voice signal provided on said at least one first channel, and at least one second input operative to receive said at least one electrical sound masking signal on said at least one second channel,
wherein each loudspeaker assembly is operative to emit at least one acoustic voice signal corresponding to said at least one electrical voice signal, and to emit at least one acoustic sound masking signal corresponding to said at least one electrical sound masking signal, simultaneously and directly into said predetermined area of said building.

2. The system of claim 1 wherein said at least one microphone is operative to provide at least one wireless voice signal corresponding to the detected speech, and said at least one receiver is operative to receive said at least one wireless voice signal from said at least one microphone.

3. The system of claim 1 further including at least one remote control unit operative to transmit one or more commands to said at least one system controller for controlling at least one level of at least one of said at least one acoustic voice signal and said at least one acoustic sound masking signal.

4. The system of claim 1 further including at least one external audio source operative to provide at least one audio input signal to said at least one system controller for subsequent transmission in said predetermined area by said plurality of loudspeaker assemblies.

5. The system of claim 1 wherein said predetermined area includes a ceiling, and said plurality of loudspeaker assemblies is spatially distributed on said ceiling to emit said at least one acoustic voice signal and said at least one acoustic sound masking signal simultaneously and directly into said predetermined area.

6. The system of claim 1 wherein said at least one sound masking signal generator is further operative to store at least one set of information, and wherein said at least one electrical sound masking signal corresponds to two or more mutually incoherent electrical sound masking signals having sound masking spectra based upon said at least one set of information.

7. The system of claim 6 wherein said at least one system controller is further operative to adjust an output level of said at least one acoustic voice signal based at least in part upon said sound masking spectra of said two or more mutually incoherent electrical sound masking signals to obtain at least one specified performance characteristic.

8. The system of claim 1 further including at least one network, said at least one system controller being communicably coupled to said at least one network.

9. The system of claim 8 wherein said at least one network is communicably coupleable to at least one emergency processor, said at least one system controller being operative to communicate with said at least one emergency processor over said at least one network to provide one or more of emergency signaling and voice communications between said at least one system controller and said at least one emergency processor.

10. The system of claim 8:
wherein said at least one microphone comprises a plurality of microphones;
wherein said at least one receiver comprises a plurality of receivers;
wherein said at least one system controller comprises a plurality of system controllers;
wherein said plurality of loudspeaker assemblies comprises a plurality of sets of loudspeaker assemblies;
wherein each of said plurality of microphones, each of said plurality of receivers, each of said plurality of system controllers, and each of said plurality of sets of loudspeaker assemblies is associated with one of a plurality of predetermined areas of at least one building; and
wherein each of said plurality of system controllers is operative to communicate with each of the other ones of said plurality of system controllers over said at least one network.

11. The system of claim 8 wherein said at least one network comprises a plurality of networks, said plurality of networks including a local network disposed within said building and the Internet.

12. The system of claim 8 further including at least one database server, said at least one system controller being communicably coupleable to said at least one database server via said at least one network.

13. The system of claim 12 wherein said at least one network includes at least one voice over Internet protocol (VoIP) network.

14. The system of claim 8:
wherein said at least one network includes at least one VoIP network;
wherein said at least one VoIP network is communicably coupleable to at least one VoIP paging interface; and
wherein said at least one VoIP paging interface is operative to provide at least one paging signal to said at least one system controller via said at least one VoIP network for subsequent transmission in said predetermined area by said plurality of loudspeaker assemblies.

15. A method of providing voice lift and sound masking capabilities, for use in a predetermined area of a building, said method comprising the steps of:
detecting speech by at least one microphone;
providing, by said at least one microphone, at least one electrical voice signal corresponding to the detected speech;
receiving, by at least one receiver, said at least one electrical voice signal from said at least one microphone;
generating, by at least one sound masking signal generator, at least one electrical sound masking signal;
receiving, by at least one system controller, said at least one electrical voice signal from said at least one receiver and said at least one electrical sound masking signal from said sound masking signal generator;
providing, by said at least one system controller to a plurality of loudspeaker assemblies, said at least one electrical voice signal on at least one first channel, and said at least one electrical sound masking signal on at least one second channel; and
emitting, by each of said plurality of loudspeaker assemblies, at least one acoustic voice signal corresponding to said at least one electrical voice signal and at least one acoustic sound masking signal corresponding to said at least one electrical sound masking signal simultaneously and directly into said predetermined area of said building.

16. A sound system having voice lift and sound masking capabilities for use in a predetermined area of a building, said system comprising:
at least one microphone operative to detect speech, and to provide at least one electrical voice signal corresponding to the detected speech;
at least one receiver operative to receive said at least one electrical voice signal from said at least one microphone;
at least one sound masking signal generator operative to generate at least one electrical sound masking signal;
at least one first system controller operative to receive said at least one electrical voice signal from said at least one receiver, and to provide said at least one electrical voice signal on at least one first channel;
at least one second system controller operative to receive said at least one electrical sound masking signal from said sound masking signal generator, and to provide said at least one electrical sound masking signal on at least one second channel;
a first plurality of loudspeaker assemblies, each of said first plurality of loudspeaker assemblies including at least one first input operative to receive said at least one electrical voice signal provided on said at least one first channel; and
a second plurality of loudspeaker assemblies, each of said second plurality of loudspeaker assemblies including at least one second input operative to receive said at least one electrical sound masking signal on said at least one second channel,
wherein each of said first plurality of loudspeaker assemblies is operative to emit at least one acoustic voice signal corresponding to said at least one electrical voice signal, and each of said second plurality of loudspeaker assemblies is operative to emit at least one acoustic sound masking signal corresponding to said at least one electrical sound masking signal, simultaneously into said predetermined area of said building.

17. A method of improving the capacity of at least one human listener to focus on at least one speech sound source in the presence of at least one distracting sound source, said method comprising the steps of:
in a predetermined area of a building comprising at least one speech sound source, at least one human listener and at least one distracting sound source, the improvement comprising the steps of:
generating, by at least one sound masking signal generator, at least one electrical sound masking signal;
receiving, by at least one system controller, said at least one electrical sound masking signal from said sound masking signal generator;
providing, by said at least one system controller to a plurality of loudspeaker assemblies, said at least one electrical sound masking signal on at least one channel; and
emitting, by each of said plurality of loudspeaker assemblies, at least one acoustic sound masking signal corresponding to said at least one electrical sound masking signal into said predetermined area of said building.

18. A method of audio communication in a predetermined area of a building, said method comprising the steps of:
providing at least one system controller having digital signal processing capability;
providing, by said at least one system controller, two or more audio communication functionalities; and
selecting, by a user, for operation at least one of said two or more audio communication functionalities provided by said at least one system controller.

19. The method of claim 18, wherein said two or more audio communication functions provided by said at least one system controller are selected from the group consisting of voice lift, sound masking, paging, pod-casting, emergency broadcasting and remote learning.
